(19) United States
(12) Patent Application Publication
(10) Pub. No.: US 2024/0265409 A1
(43) Pub. Date: Aug. 8, 2024

(54) METHODS FOR DETERMINING LOCATIONS OF PASSENGER FLOW CORRIDORS BASED ON CARD SWIPING DATA

(71) Applicant: ANHUI JIAOXIN TECHNOLOGY CO., LTD., Hefei (CN)

(72) Inventors: Zihui REN, Hefei (CN); Lei LIU, Hefei (CN); Jingjing LUO, Hefei (CN); Wei WANG, Hefei (CN); Hongchang GAO, Hefei (CN); Mengyuan JIANG, Hefei (CN); Xiaojuan WANG, Hefei (CN); Yehua PENG, Hefei (CN); Xiang YAO, Hefei (CN); Qiyun YAN, Hefei (CN); Yongsheng GE, Hefei (CN); Zhangya WEI, Hefei (CN); Caifeng CHEN, Hefei (CN)

(73) Assignee: ANHUI JIAOXIN TECHNOLOGY CO., LTD., Hefei (CN)

(21) Appl. No.: 18/467,819

(22) Filed: Sep. 15, 2023

(30) Foreign Application Priority Data
Feb. 7, 2023 (CN) 202310070131.6

(51) Int. Cl. G06Q 30/0201

(52) U.S. Cl. CPC G06Q 30/0201

(57) ABSTRACT

The present disclosure discloses a method for determining a location of a passenger flow corridor based on card swiping data. The method includes collecting data, obtaining a station passenger flow of a “new road”, determining the location of the passenger flow corridor, testing an accuracy of the location of the passenger flow corridor, and displaying the location of the passenger flow corridor through WebGIS. Basic information such as boarding stations, card swiping time, and affiliated roads can be obtained by stable matching, and then stations can be clustered and rearranged to the new road on which routes and roads are fitted. A largest station passenger flow in a whole region is selected, and a station passenger flow of each road is determined through grade classification, so that the locations of the passenger flow corridors in the whole region are accurately selected.

### CROSS-REFERENCE TO RELATED APPLICATIONS

This application claims priority to Chinese Patent Application No. 202310070131.6, filed on Feb. 7, 2023, the entire content of which is hereby incorporated by reference.

### TECHNICAL FIELD

The present disclosure relates to the technical field of public transportation passenger flow analysis, and more specifically, to a method for determining a location of a passenger flow corridor based on card swiping data.

### BACKGROUND

Urban public transportation passenger flow corridors refer to main public transportation routes connecting major passenger flow origins within a certain region, with a common flow direction. The development and location of passenger flow corridors can significantly enhance the efficiency of urban public transportation, holding great importance for the advancement of urban transit.

Current research on passenger flow corridors often starts from the perspective of passenger flow origin-destination (OD) pairs, matching passenger flows using trip chain algorithms to study the distribution of passenger flow corridors. While this approach is feasible from a general perspective of passenger flow distribution, it tends to omit a large amount of unconventional passenger flows and fails to match corresponding flows accurately. Under this approach, the formation of passenger flow corridors can only provide trends without offering precise passenger flow data.

### SUMMARY

The present disclosure aims to provide a method for determining a location of a passenger flow corridor based on card swiping data. Basic information such as boarding stations, card-swiping time, and affiliated roads may be obtained using stable matching, and then the stations may be clustered and rearranged to a new road on which a route and a road are fitted. Then, a largest station passenger flow in a whole region may be selected, and a station passenger flow of each road may be determined through hierarchical classification, so that locations of passenger flow corridors in the whole region may be eventually and accurately selected, thereby solving the problems presented in the aforementioned background technology.

To achieve the above-mentioned objectives, the present disclosure provides the following technical solution.

A method for determining a location of a passenger flow corridor based on card swiping data, implemented based on a processor, may include following operations.

S1. data collection: basic station data of a hardware device of an electronic station board may be collected, passenger flow data during operation may be obtained, and the basic station data and the passenger flow data may be stored in an SqI Server database; and the basic station data and the passenger flow data may be pre-processed, and an obtained total count of station passenger flow may be stored in the SqI Server database.

S2. a passenger flow of a “new road” may be obtained: the station passenger flow data and a name of the station stored in the SqI Server database in step S1 may be called, and upward and downward passenger flows may be aggregated according to the name of the station; incompleteness may be improved when road information is obtained by fitting GPS point data formed in route operation with road data using WebGIS, and the “new road” after curve fitting may be formed by eliminating roads not covered by an urban bus; and stations and station passenger flows on the “new road” may be obtained by calling properties of roads to which the stored stations belong to rearrange the stations on the “new road”, wherein the stations on the “new road” are stored as static data, and the station passenger flows on the “new road” are stored as dynamic passenger flows according to a time period;

S3. the location of the passenger flow corridor may be determined: the stations and the station passenger flows on the “new road” obtained in step S2 may be called, all the station passenger flows on the “new road” in a whole region in a same time period may be selected, and a largest station passenger flow Sₘₐₓ in a current time period may be dynamically selected, and the station passenger flows may be classified into grade I, grade II, and grade III according to the station passenger flow Sₘₐₓ.

A certain road L may be selected, a station grade on the road L may be determined, a station Sᵢ on the road L may be divided into grade I-1₁, grade II-1₂, and grade III-1₃ based on a k-means clustering algorithm, and a proportion of grade 1₁ on the road L may be calculated; wherein since a location of a largest passenger flow corridor is considered, only a location of a passenger flow corridor that belongs to the grade I may be considered;

S4. an accuracy of the location of the passenger flow corridor may be tested: a traffic cell may be equalized according to points of interest (POIs), wherein a passenger flow density of the traffic cell equals to a ratio of a passenger flow of the traffic cell to an area of the traffic cell.

For the results of step S3 satisfying a condition, a regional passenger flow density of the results satisfying the condition may be calculated, and a passenger flow density of the traffic cell divided according to the POIs may be calculated; in response to a ratio of the regional passenger flow density to the passenger flow density being less than 80%, it may not determine a road corresponding to the regional passenger flow density as the location of the passenger flow corridor, and in response to the ratio of the regional passenger flow density to the passenger flow density being greater than or equal to 80%, it may determine the road corresponding to the regional passenger flow density as the location of the passenger traffic corridor, and storing screened results in the SqI Server database; and

S5. the location of the passenger flow corridor may be displayed through WebGIS: the results stored in step S4 may be called, the location of the passenger flow corridor may be displayed according to thick and thin markings of line segments based on the new road fitted by a GIS map to display the location of the passenger flow corridor.

As a further embodiment of the present disclosure, the pre-processing in step S1 may include the following operations. stable matching may be performed on dynamic GPS data returned by a vehicle-mounted device and a GPS location of the station, and passenger flows of a dynamic GPS point from a GPS point of a station A to a GPS point of a next station in the vehicle-mounted device may belong to the passenger flow of the station A.

As a more detailed embodiment of the present disclosure, the location of the passenger flow corridor in the step S3 may be calculated by a process including following operations.

A certain station Sᵢ on the road L may be selected, then

$$\{ \begin{matrix}{S}_{i} ϵ I … {S}_{i} = 1 \\ {S}_{i} ∉ I … {S}_{i} = 0\end{matrix} ;$$

An overall proportion of the station Sᵢ on the road satisfying the condition Sᵢ∈I may be calculated, then

$${P}_{{I}_{1}} = Σ {S}_{i} / {L}_{s} ;$$

where
Lₛ denotes a summary of passenger flows of all stations on the road L;
A proportion of all 1₁ road segments on corresponding roads in the whole region may be calculated using the method, and the proportion may be compared with a standard in the whole region, wherein roads of which P_{I}_{₁} is larger than a standard range belong to the location of the passenger flow corridor in the whole region, which is represented by the following formula.

$$\{ \begin{matrix}{P}_{{l}_{1}} \geq \frac{{\sum }_{i = 1}^{n} {P}_{{l}_{1}}}{N} + C … {P}_{{l}_{1}} = 1 \\ {P}_{{l}_{1}} < \frac{{\sum }_{i = 1}^{n} {P}_{{l}_{1}}}{N} + C … {P}_{{l}_{1}} = 0\end{matrix} ;$$

where
Pl₁ denotes the proportion of I₁ road segment on the whole road;
N denotes a total count of stations satisfying the condition;
C denotes a constant variable;
i=1 denotes a first station on the road;
n denotes an nth station on the road; and
If Pl₁=1, then the roads of which P=1 belong to the location of the passenger flow corridor in the whole region; if Pₗ=0, then the roads of which P=0 do not belong to the location of the passenger flow corridor in the whole region.

### BRIEF DESCRIPTION OF THE DRAWINGS

FIG. 1 is a flowchart illustrating a method for determining a location of a passenger flow corridor based on card swiping data;

FIG. 2 is a map of a road before optimization according to the embodiments of the present disclosure;

FIG. 3 is a map of a “new road” after optimization according to the embodiments of the present disclosure; and

FIG. 4 is a route network map illustrating a location of a passenger flow corridor according to the embodiments of the present disclosure.

### DETAILED DESCRIPTION

The technical solutions of the present disclosure will be further described in detail with reference to the specific embodiments.

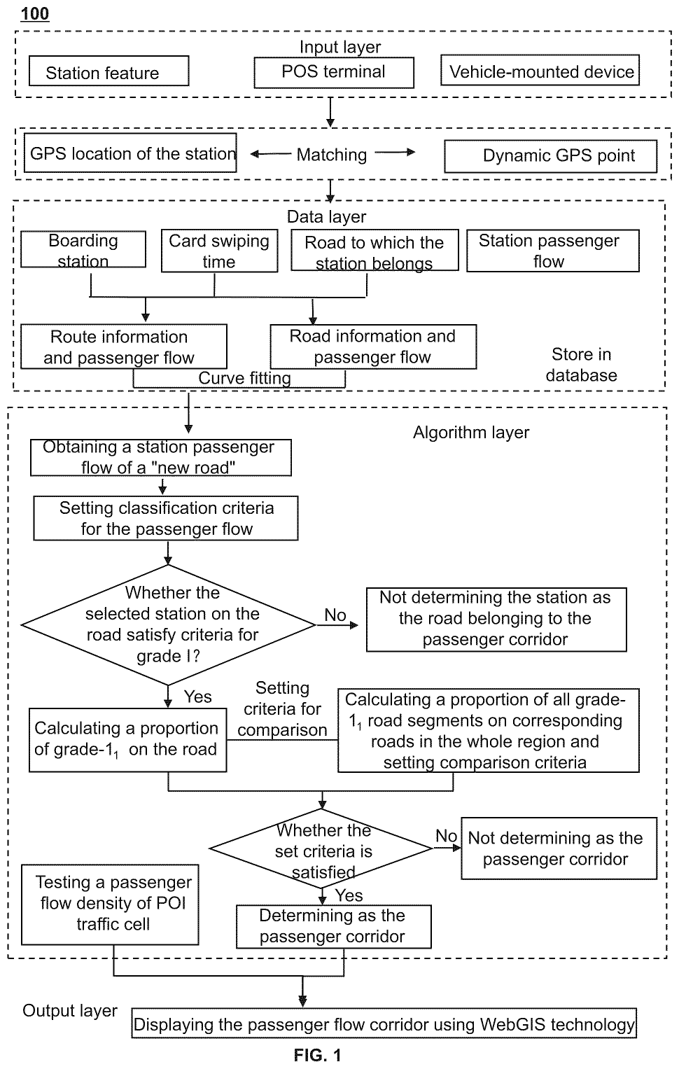

Please refer to FIG. 1. FIG. 1 is a flowchart illustrating an exemplary method for determining a location of a passenger flow corridor based on card swiping data according to some embodiments of the present disclosure. In some embodiments, the method for determining the location of the passenger flow corridor based on the card swiping data may be implemented by a processor. The processor refers to a device with computing capability, e.g., a central processing unit (CPU), etc. The processor may implement a program instruction to perform one or more functions described in the present disclosure using data, information, and/or processing results obtained from other devices.

The method for determining the location of the passenger flow corridor based on the card swiping data may include the following operations.

(1) Data collection: basic station data of a hardware device of an electronic station board may be collected, including a station name, a GPS location of the station, and a road to which the station belongs, and the basic station data may be stored in a SqI Server database. In some embodiments, the processor may obtain the basic station data through the hardware device of the electronic station board. The basic station data may include one or more of the station name, the GPS location of the station, and the road to which the station belongs. The hardware device of the electronic station board may collect the basic station data directly.

Passenger flow data may be obtained in an operation process, including a Card ID and card swiping time, and the passenger flow data may be stored in the SqI Server database. Accordingly, the basic station data and the passenger flow data may be pre-processed by a process including the following operations. Stable matching may be performed on dynamic GPS data returned by a vehicle-mounted device and the GPS location of the station, and passenger flows of a dynamic GPS point from a GPS point of a station A to a GPS point of a next station in the vehicle-mounted device may belong to the passenger flow of the station A. A total count of passenger flows may be eventually obtained and stored in the SqI Server database. The passenger flow data refers to the data related to passenger flows. The passenger flow data may include the Card ID, the card swiping time, etc. In some embodiments, the processor may obtain the passenger flow data through the vehicle-mounted device. The vehicle-mounted device refers to a machine installed on a bus that runs with the bus, e.g., a bus payment terminal, etc.

(2) A passenger flow of a “new road” may be obtained. The station passenger flow data and the station name stored in the SqI Server database in step S1 may be called, and upward and downward passenger flows may be aggregated according to the station name; and incompleteness may be improved when road information is obtained by fitting GPS point data formed in route operation with road data using WebGIS, and the “new road” after curve fitting may be formed by eliminating roads not covered by the urban bus. The “new road” refers to all roads through which the urban bus passes.

Stations and station passenger flows on the “new road” may be obtained by calling properties of roads to which the stored stations belong to rearrange the stations on the “new road”, wherein the stations on the “new road” may be stored as static data, and the station passenger flows on the “new road” may be stored as dynamic passenger flows according to a time period.

(3) The location of the passenger flow corridor may be determined. The stations and the station passenger flows on the “new road” obtained in step S2 may be called, and the station passenger flows on the “new road” in a whole region in a same time period may be calculated. A largest station passenger flow Sₘₐₓ in a current time period may be dynamically selected, and the station passenger flows may be classified into grade I, grade II, and grade III according to the station passenger flow Sₘₐₓ. The classification may be shown in Table 1 below (The classification in the present disclosure may be performed based on experience values of the public transportation industry, and the classification may be adjusted according to special needs of a specific region).

TABLE 1

| Grade | Classification Criteria |
|---|---|
| Grade I | Sₘₐₓ *80% ≤ Sᵢ ≤ Sₘₐₓ *100% |
| Grade II | Sₘₐₓ *40% ≤ Sᵢ ≤ Sₘₐₓ *80% |
| Grade III | Sᵢ ≤ Sₘₐₓ *40% |

A certain road L may be selected, a station Sᵢ on the road L may be divided into grade I-1₁, grade II-1₂, and grade III-1₃ based on a k-means clustering algorithm to obtain classification criteria in Table 1, and a proportion of grade 1₁ on the road L may be calculated. The location of the passenger flow corridor refers to a location that forms a road between at least two consecutive stations belonging to the grade I.

In some embodiments, the processor may determine a feature vector corresponding to each station based on a distance from each station to a next station on the road L and a passenger flow of each station. The processor may also perform clustering on all stations on the road L based on the feature vectors corresponding to the stations through the K-means clustering algorithm, so as to divide the station Sᵢ on road L into the grade I-1₁, the grade II-1₂, and the grade III-1₃.

The feature vector refers to a feature vector constructed based on a distance from a certain station to a next station on the road L and a passenger flow of the station. For example, the feature vector may include a distance from a station A to a next station B on the road L and a passenger flow of the station A.

In some embodiments, the processor may perform clustering on all stations on the road L based on the feature vector corresponding to each station through the K-means clustering algorithm by a process including the following operations.

Step 1: a graded count (e.g., 3) of stations may be selected from all stations on the road L as initial clustering centers, and each station may represent the initial clustering center of a cluster.

Step 2: for all stations on the road L, each station may be clustered to a cluster corresponding to a cluster center closest to the each station according to a minimal distance criterion based on a vector distance (e.g., Euclidean distance) between a feature vector of each station and a feature vector corresponding to each cluster center.

Step 3: for each cluster completing clustering, a mean of all feature vectors in the cluster may be calculated. A new clustering center may be constructed based on the mean, and the new clustering center may be used as an updated clustering center of the corresponding cluster.

Step 4: whether the feature vectors corresponding to a previous clustering center and the feature vectors corresponding to the updated clustering center change may be determined. If the feature vectors do not change, clustering may be completed; and if the feature vectors change, the clustering center in Step 2 may be replaced with the updated clustering center, and the process of Steps 2-4 may be iterated until the clustering is completed.

In some embodiments, the processor may, based on the station passenger flows of the three grades obtained from clustering, sort a total passenger flow of each class obtained through clustering in a descending order, and the three grades obtained by sorting may be sequentially named as the grade I-1₁, the grade II-1₂, and the grade III-1₃.

In some embodiments of the present disclosure, the feature vector corresponding to each station may be determined by considering the distance from each station on the road L to the next station and the passenger flow of each station. All stations on the road L may be clustered using the K-means clustering algorithm, so that the accuracy of dividing the station Sᵢ on the road L into the grade I-1₁, the grade II-1₂, and the grade III-1₃ may be guaranteed.

In the present disclosure, since a location of a largest passenger flow corridor is considered, only a location of a passenger flow corridor that belongs to the grade I may be considered, which is specifically calculated as follows.

A certain station Sᵢ on the road L may be selected, then

$$\{ \begin{matrix}{S}_{i} ϵ I … {S}_{i} = 1 \\ {S}_{i} ∉ I … {S}_{i} = 0\end{matrix} .$$

An overall proportion of the station Sᵢ on the road satisfying the condition Sᵢ∈I may be calculated, then

$${P}_{{I}_{1}} = Σ {S}_{i} / {L}_{s} ;$$

where

Lₛ denotes a summary of station passenger flows on the road L.

A proportion of all I₁ road segments on corresponding roads in the whole region may be calculated using the method, and the proportion may be compared with a standard (as shown below) in the whole region, where roads of which P_{I}_{₁} is larger than a standard range may be the locations of the passenger flow corridors in the whole region, which is represented by:

$$\{ \begin{matrix}{P}_{{l}_{1}} \geq \frac{{\sum }_{i = 1}^{n} {P}_{{l}_{1}}}{N} + C … {P}_{{l}_{1}} = 1 \\ {P}_{{l}_{1}} < \frac{{\sum }_{i = 1}^{n} {P}_{{l}_{1}}}{N} + C … {P}_{{l}_{1}} = 0\end{matrix} ;$$

where
P_{I}_{₁}, denotes a proportion of I₁ road segments on the whole road;
N denotes a total count of stations satisfying the condition;
C denotes a constant variable;
i=1 denotes a first station on the road;
n denotes an nth station on the road; and
If P_{I}_{₁}=1, then the roads of which P_{I}_{₁}=1 may belong to the locations of the passenger flow corridors in the whole region; if P_{I}_{₁}=0, then the roads of which P_{I}_{₁}=0 do not belong to the locations of the passenger flow corridors in the whole region.

When passenger flows of a plurality of consecutive stations do not satisfy the condition for the grade I stations but are close to the condition for grade I stations (e.g., the passenger flows of the grade I stations are 80%*Sₘₐₓ, but the passenger flows of three consecutive stations all exceed 78%*Sₘₐₓ), if the plurality of consecutive stations are not included in the grade I-1₁, it may lead to a significant loss of the passenger flow data. Therefore, the plurality of consecutive stations may be merged in the following way to form merged grade I stations, which may be added to grade I-1₁ to ensure the integrity of the passenger flow data. The plurality of consecutive stations refer to a plurality of adjacent stations.

In some embodiments, in response to a sum of passenger flows of at least two consecutive stations on the any road L satisfying a preset passenger flow condition, the processor may merge the at least two consecutive stations to obtain the merged grade I stations, which may be added to grade I-1₁.

The station passenger flow refers to a count of passengers boarding a bus at a certain station (e.g., a bus stop). In some embodiments, card swiping data (e.g., a count of card swipes) at the bus stop may reflect the station passenger flow. For example, the more card swipes occur at the certain station, the higher the passenger flow of the station.

In some embodiments, the processor may determine the card swiping data of the bus based on passenger flow data obtained by a vehicle-mounted device on the bus. For example, the processor may determine a count of Card IDs of each station in the passenger flow data obtained by the vehicle-mounted device as the card swiping data (e.g., the count of card swipes) of each station.

In some embodiments, the preset passenger flow condition may include that at least two consecutive stations belong to the grade II-1₂ or the grade III-1₃, and a sum of passenger flows of the at least two consecutive stations exceeds a merging threshold. For example, the preset passenger flow condition may include that consecutive stations T1, T2, T3, T4, . . . , and Tn (where n≥2) belong to grade II or III stations, and the sum of passenger flows of the at least two consecutive stations exceeds the merging threshold. The two consecutive stations may include T1+T2, T2+T3, T3+T4, etc.; and the three consecutive stations may include T1+T2+T3, T2+T3+T4, etc. Similarly, all stations included in four consecutive stations, . . . , or in n consecutive stations may be obtained.

In some embodiments, the merged consecutive stations may not be merged with remaining consecutive stations. The sum of passenger flows may be calculated and compared with a corresponding candidate merging threshold for subsequent comparison and determination. For example, if there are consecutive stations T1, T2, T3, and T4 belonging to grade II or grade III, and if the sum of passenger flows of the consecutive stations T1+T2 exceeds the corresponding candidate merging threshold, and roads between the consecutive stations T1 and T2 have already been merged into the location of the passenger flow corridor, T1 and/or T2 may not be merged with the remaining consecutive stations T3 and/or T4 any more for subsequent comparison and determination by calculating the sum of passenger flows of T2+T3, T1+T2+T3, or T2+T3+T4 or comparing the sum of passenger flows with the corresponding candidate merging thresholds.

The merging threshold refers to a critical value of the sum of passenger flows of the merged consecutive stations. In some embodiments, the merging thresholds corresponding to the sum of passenger flows for different counts of merged consecutive stations may vary. In some embodiments, the merging threshold may be preset by those skilled in the art based on experience. For example, the merging threshold may be a passenger flow value used to determine whether a station is a grade I station.

The processor may also determine the merging threshold in other ways.

In some embodiments, the processor may determine the merging threshold based on a count of the merged consecutive stations and a road length covered by the merged consecutive stations. For example, the more the count of the merged consecutive stations and the longer the road length covered by the merged consecutive stations, the larger the merging threshold determined by the processor.

In some embodiments, the processor may determine the merging threshold through a first preset lookup table based on the count of merged consecutive stations and the road length covered by the merged consecutive stations. The first preset lookup table may include a corresponding relationship between different reference counts of merged consecutive stations and reference road lengths covered by the merged consecutive stations and reference merging thresholds. The first preset lookup table may be constructed based on prior knowledge or historical data.

In some embodiments of the present disclosure, the merging threshold may be determined through the count of the merged consecutive stations and the road length covered by the merged consecutive stations, thereby improving the accuracy of the determined merging threshold.

In some embodiments, the processor may also construct a regional passenger flow map based on all bus stops and road information on the road L; and determine merging thresholds of different regions on the road L through a threshold determination model based on the regional passenger flow map.

The road information refers to information related to a segment of road on the road L. For example, the road information may include a length and a width of a road between adjacent bus stops.

In some embodiments, the processor may call all the bus stops and the road information of the road L from the SqI Server database. More descriptions regarding the SqI Server database and the “new road” may be found in the previous descriptions.

The regional passenger flow map may reflect a passenger flows of each bus stop on the road L. In some embodiments, the regional passenger flow map refers to a data structure composed of nodes and edges, where the edges connect the nodes, and both the nodes and the edges may possess attributes.

In some embodiments, the nodes in the regional passenger flow map may correspond to each bus stop on the road L. Node attributes may reflect relevant features of the corresponding bus stop. For example, the node attributes may include a passenger flow of the bus stop, a count of bus lines passing through the bus stop, and a population center near the bus stop (e.g., malls, office buildings, residential complexes within a range of 500 m of the bus stop).

In some embodiments, the edges in the regional passenger flow map may correspond to roads between two adjacent bus stops on the road L. In some embodiments, the edges may be directed edges, and directions of the edges may be determined by travel directions of the bus. For example, the directions of the edges may represent a direction in which the bus travels from a bus departure to a bus terminal.

Edge attributes may reflect features of corresponding road segments. For example, the edge attributes may include a length and a width of a road between adjacent bus stops.

In some embodiments, the processor may construct the regional passenger flow map using a Geographic Information System (GIS) mapping technology based on all the bus stops, the road information, and the passenger flows corresponding to the bus stops on the road L. The GIS mapping technology refers to a technology integrating all the bus stops, the road information, the passenger flows corresponding to the bus stops, and geographical location information of the road L onto a map.

The region refers to a region composed of at least two consecutive bus stops on the road L. The two consecutive bus stops may belong to the grade II-I₂ or the grade III-I₃. A regional division rule may be preset by those skilled in the art based on experience. For example, regional division may be performed on the road L based on administrative boundaries or other division criteria.

In some embodiments, the threshold determination model may be a machine learning model, such as a Graph Neural Network (GNN) model.

In some embodiments, an input of the threshold determination model may include the regional passenger flow map, and an output of the threshold determination model may include the merging thresholds of different regions on the road L. The merging thresholds of different regions refer to merging thresholds corresponding to regions composed of at least two consecutive stations belonging to the grade II-I₂ or the grade III-I₃.

In some embodiments, the threshold determination model may be trained based on a large count of labeled training samples. In some embodiments, each set of training samples may include historical sample regional passenger flow maps corresponding to historical sample roads L, and labels of each set of training samples may be merging thresholds of different historical sample regions on historical sample roads L.

In some embodiments, the processor may construct the historical sample regional passenger flow maps as the training samples based on all historical bus stops on historical roads L, historical road information, and historical passenger flows corresponding to the historical bus stops from historical databases.

In some embodiments, the historical passenger flows corresponding to the historical bus stops may be related to historical card swiping data of the historical bus stops. For example, the larger the historical card swiping data (e.g., the card swiping time) of the historical bus stops, the larger the historical passenger flows corresponding to the historical bus stops. In some embodiments, the historical card swiping data of the historical bus stops may be historical card swiping data of the historical bus stops corresponding to historical bus operation plans in the historical databases whose historical operation effects satisfy a preset operation condition.

The historical databases may store a plurality of historical bus operation plans and the historical card swiping data and the historical operation effects corresponding to the plurality of historical bus operation plans. The historical databases may be the SqI Server database. The historical bus operation plans refer to historical bus scheduling plans. The historical operation effects refer to historical operation effects corresponding to the historical bus operation plans, such as excellent, good, average, and poor historical operation effects.

In some embodiments, card swiping data corresponding to the excellent, good, average, and poor historical operation effects may be preset in sequence. The processor may determine the historical operation effects of the historical bus operation plans by comparing the historical card swiping data corresponding to the historical bus operation plans with the card swiping data corresponding to the excellent, good, average, and poor historical operation effects. The preset operation condition may be determined by those skilled in the art based on experience, e.g., the historical operation effect being excellent or good.

In some embodiments, the processor may filter out the historical card swiping data of the historical bus stops corresponding to the historical bus operation plans that satisfy the preset operation condition based on the historical databases, thereby obtaining the historical passenger flows corresponding to the historical bus stops.

In some embodiments, the processor may construct the historical sample regional passenger flow maps using the GIS mapping technology based on all the historical bus stops on the historical roads L, the historical road information, and the historical passenger flows corresponding to the historical bus stops from the historical databases.

In some embodiments, the processor may determine training labels using the following steps S1-S3.

Step S1: a plurality of virtual locations of passenger flow corridors may be determined based on a plurality of preset candidate merging thresholds and passenger flows of at least two consecutive stations.

In some embodiments, different counts of the merged consecutive stations may correspond to different preset candidate merging thresholds. The preset candidate merging thresholds may be determined by those skilled in the art based on experience.

The virtual locations of the passenger flow corridors refer to virtual locations of roads between the at least two consecutive stations belonging to the grade I.

In some embodiments, the processor may compare a sum of the passenger flows of the at least two consecutive stations with the corresponding preset candidate merging threshold. If the sum of the passenger flows of the merged consecutive stations exceeds the corresponding candidate merging threshold, the roads between the merged consecutive stations may be merged into the virtual locations of the passenger flow corridors, thereby determining the plurality of virtual locations of the passenger flow corridors. More explanation regarding the at least two consecutive stations may be found in the previous descriptions. For example, if there are consecutive stations T1, T2, T3, . . . , and Tn (where n≥2) belonging to the grade II or the grade III, the processor may sequentially determine whether a sum of the passenger flows of 2, 3, 4, . . . , and n consecutive stations exceeds the corresponding candidate merging threshold. If the sum of the passenger flows exceeds the corresponding candidate merging threshold, the roads between the merged consecutive stations with the sum of the passenger flows exceeding the corresponding candidate merging threshold may be merged into the virtual locations of the passenger flow corridors.

In some embodiments, the processor may not merge the merged stations with the remaining consecutive stations to calculate and compare the sum of the passenger flows with the corresponding candidate merging thresholds for subsequent comparison and determination. For example, if there are consecutive stations T1, T2, T3, and T4 belonging to the grade II or the grade III, the sum of the passenger flows of the consecutive stations T1 and T2 exceeds the corresponding candidate merging threshold and the roads between T1 and T2 have been merged into the locations of the passenger flow corridors, the processor may not merge T1 and/or T2 with the remaining consecutive stations T3 and/or T4, i.e., the processor may not perform comparison between the sum of the passenger flows of T2+T3, T1+T2+T3, or T2+T3+T4 and the corresponding candidate merging thresholds for subsequent determination.

Step S2: a plurality of virtual bus operation plans may be formulated based on the plurality of virtual locations of passenger flow corridors.

In some embodiments, the processor may determine the plurality of virtual bus operation plans based on the plurality of virtual locations of the passenger flow corridors and operation strategies of bus operators through a second preset lookup table. The second preset lookup table may include a correspondence relationship between a plurality of reference virtual locations of passenger flow corridors, reference operation strategies of bus operators, and a plurality of reference virtual bus operation plans. The second preset lookup table may be constructed based on prior knowledge or historical data. The operation strategies of the bus operators may be preset by those skilled in the art according to practical needs.

Step S3: virtual bus operation plans closest to the plurality of historical bus operation plans in the historical databases may be selected from the plurality of virtual bus operation plans, and candidate merging thresholds corresponding to the virtual bus operation plans closest to the plurality of historical bus operation plans may be used as the training labels.

In some embodiments, the processor may calculate a vector distance (e.g., Euclidean distance) between each of the plurality of virtual bus operation plans and the plurality of historical bus operation plans in the historical databases, and determine a virtual bus operation plan with a shortest vector distance as the virtual bus operation plan closest to the plurality of historical bus operation plans in the historical databases. Then the processor may determine a candidate merging threshold corresponding to the virtual bus operation plan closest to the plurality of historical bus operation plans in the historical databases as the training label. Each bus operation plan (e.g., each of the plurality of virtual bus operation plans, and each of the plurality of historical bus operation plans) may correspond to a bus feature vector. The bus feature vector refers to a feature vector constructed based on bus operation time and a bus operation route corresponding to the bus operation time.

In some embodiments of the present disclosure, the historical sample regional passenger flow maps may be constructed as the training samples based on the card swiping data corresponding to the bus operation plans with good or excellent operation effects in the historical databases, all the historical bus stops on the historical roads L, and the historical road information. The candidate merging thresholds corresponding to the virtual bus operation plans closest to the plurality of historical bus operation plans in the historical databases may be determined as the training labels, thereby enhancing the prediction accuracy of the threshold determination model obtained by training, and accurately predicting the merging thresholds of different regions.

In the present disclosure, further verification may be required to test correctness of the location of the passenger flow corridor.

(8) The accuracy of the location of the passenger flow corridor may be tested. A traffic cell may be equalized according to points of interest (POIs), where a passenger flow density of the traffic cell may be expressed as a ratio of a passenger flow of the traffic cell to an area of the traffic cell. The passenger flow of the traffic cell refers to a count of people flowing into the traffic cell within a preset time period. The preset time period may be set by those skilled in the art based on experience.

In some embodiments, the processor may equalize the traffic cell according to the POIs. The processor may cluster the POIs based on geographic locations of the POIs (e.g., latitude and longitude information) using a clustering algorithms (e.g., a K-Means algorithm) to define a region formed by the closely situated POIs as the traffic cell.

A regional passenger flow density of results satisfying Sᵢ∈I, may be calculated for the results of step S3 satisfying Sᵢ∈I, and a passenger flow density of the traffic cell divided according to the POIs may be calculated. In response to a ratio of the regional passenger flow density to the passenger flow density being less than 80%, a road corresponding to the regional passenger flow density may not be determined as the location of the passenger flow corridor; and in response to the ratio of the regional passenger flow density to the passenger flow density being greater than or equal to 80%, the road corresponding to the regional passenger flow density may be determined the location of the passenger traffic corridor, and the selected results may be stored in the SqI Server database.

(5) The passenger flow corridor may be displayed through WebGIS. The results stored in step S4 may be called, and the location of the passenger flow corridor may be displayed according to thick and thin markings of line segments based on the new road fitted by a GIS map, thereby visually displaying the location of the passenger flow corridor.

The technical solution of the present disclosure may be further analyzed and described by the following embodiments.

The basic information such as the boarding stations, the card swiping time, and the affiliated roads may be obtained through stable matching, and then the stations may be clustered and rearranged to the new road on which the routes and the roads are fitted. Then, the largest station passenger flow in the whole region may be selected, and the station passenger flow of each road may be determined through grade determination, so that the locations of the passenger flow corridors in the whole region may be eventually and accurately selected. Determining the locations of passenger flow corridors can provide operators with a visual understanding of passenger flow distribution, offer instructive recommendations for aligning operation capacity with passenger flows, establish the foundational basis for schedule planning based on the passenger flow distribution, and ultimately enhance the quality of public transportation services.

### EXAMPLES

A method for determining a location of a passenger flow corridor based on card swiping data comprises the following operations.

(1) Data collection: card swiping data returned by a vehicle-mounted device on a bus in Hefei city was selected. After undergoing data cleaning and analysis, the data was stored and imported into an SqI server database. Part of the data after data attribution was shown in Table 2.

TABLE 2

| | | | Station | | | | |
|---|---|---|---|---|---|---|---|
| Station | Station | Station | passenger | Road | Route | Route | Route |
| ID | Name | No. | Flow | Direction | ID | Name | Direction |
| 2186 | South Gate | 1 | 247 | Susong | 1 | 1 | 1 |
| | Transfer | | | Road-East | | | |
| | Center | | | | | | |
| 7923 | Xuehe | 2 | 249 | Susong | 1 | 1 | 1 |
| | South | | | Road-East | | | |
| 2019 | Xuehe North | 3 | 190 | Susong | 1 | 1 | 1 |
| | | | | Road-East | | | |
| 844 | Zhang | 4 | 143 | South 2nd | 1 | 1 | 1 |
| | Xiaoying | | | Ring Road- | | | |
| | | | | North | | | |
| 2617 | Chenfeng | 5 | 174 | South 2nd | 1 | 1 | 1 |
| | Yuan | | | Ring Road- | | | |
| | | | | North | | | |
| 6839 | Jinti | 6 | 3 | Jinzhai | 1 | 1 | 1 |
| | Intersection | | | Road- | | | |
| | | | | Central | | | |
| 6840 | Municipal | 7 | 5 | Jinzhai | 1 | 1 | 1 |
| | Workers' | | | Road- | | | |
| | Cultural | | | Central | | | |
| | Center | | | | | | |
| 7909 | South Qili | 8 | 300 | Jinzhai | 1 | 1 | 1 |
| | Station | | | Road-East | | | |
| | North | | | | | | |
| 6843 | Mechanical | 9 | 2 | Jinzhai | 1 | 1 | 1 |
| | Research | | | Road- | | | |
| | Institute | | | Central | | | |
| 6841 | USTC East | 10 | 3 | Jinzhai | 1 | 1 | 1 |
| | Campus | | | Road- | | | |
| | | | | Central | | | |
| 6842 | University of | 11 | 0 | Jinzhai | 1 | 1 | 1 |
| | Science and | | | Road- | | | |
| | Technology | | | Central | | | |
| | of China | | | | | | |
| | (USTC) | | | | | | |
| 103 | Anhui | 12 | 312 | Jinzhai | 1 | 1 | 1 |
| | Medical | | | Road- East | | | |
| | University | | | | | | |
| | Affiliated | | | | | | |
| | Hospital | | | | | | |
| 4502 | Daoxiang | 13 | 379 | Jinzhai | 1 | 1 | 1 |
| | Pavilion | | | Road-East | | | |
| 3373 | Jionglong | 14 | 147 | Jinzhai | 1 | 1 | 1 |
| | Bridge | | | Road-East | | | |
| 4436 | Sanxiaokou | 15 | 103 | Jinzhai | 1 | 1 | 1 |
| | | | | Road- East | | | |
| 3472 | Feifeng | 16 | 1 | Changjiang | 1 | 1 | 1 |
| | Street | | | Middle | | | |
| | | | | Road- | | | |
| | | | | Central | | | |
| 3473 | Sipailou | 17 | 12 | Changjiang | 1 | 1 | 1 |
| | | | | Middle | | | |
| | | | | Road- | | | |
| | | | | Central | | | |

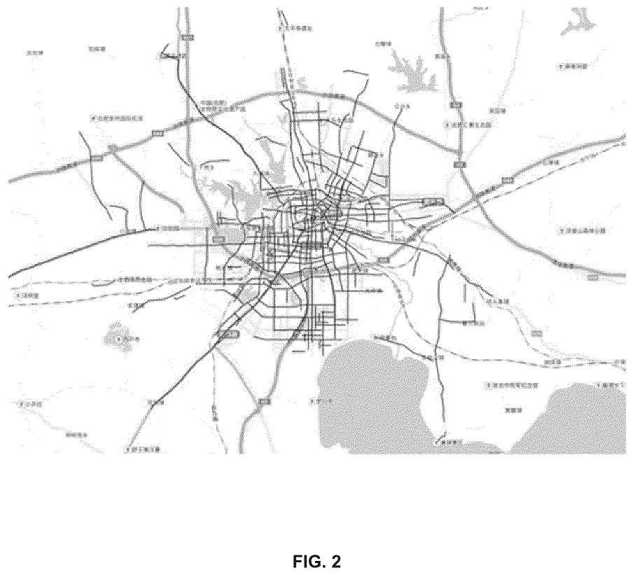

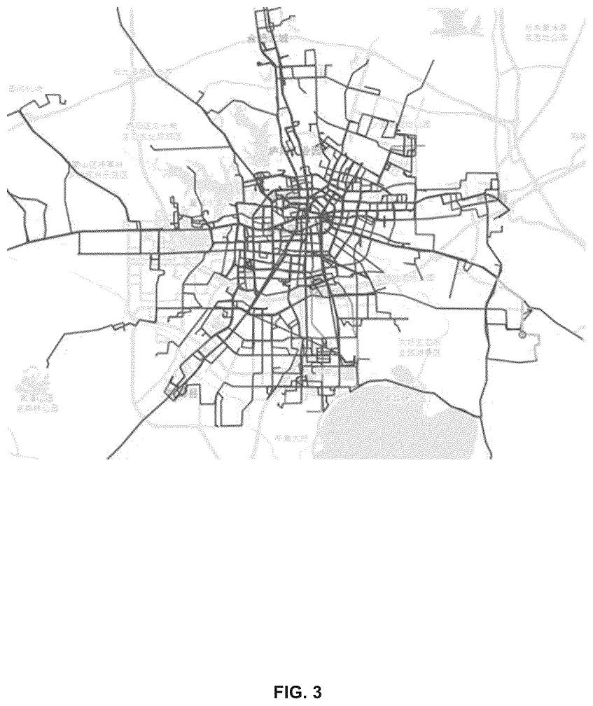

(2) A passenger flow of a “new road” was obtained. A “new road” map was redrawn using a GIS map simulation technology based on road information of stations. The redrawn “new road” map was then curve-fitted to a bus travel route to obtain an optimized “new road” map. The data was stored as static data in a database. A comparison before and after the optimization was illustrated in FIGS. 2-3.

The stations were rearranged according to roads and GPS locations of the stations and stored as dynamic data, wherein the rearrangement rule was road+sequential number. The rearranged data was presented in Table 3.

TABLE 3

| Station Name | Road No. | Passenger Flow |
|---|---|---|
| Dazhonglou North | Huizhou Avenue West-1 | 2812 |
| Dong Chengang | Huizhou Avenue West-2 | 2308 |
| Gaowangqiao | Huizhou Avenue West-3 | 22 |
| Guantang | Huizhou Avenue West-4 | 18 |
| Huimin | Huizhou Avenue West-5 | 1520 |
| Ling Datang | Huizhou Avenue West-6 | 1336 |
| Meilan | Huizhou Avenue West-7 | 770 |
| Meidan | Huizhou Avenue West-8 | 172 |
| South Xunmenqiao North | Huizhou Avenue West-9 | 1322 |
| South Xunmenqiao South | Huizhou Avenue West-10 | 1904 |
| Sipailou | Huizhou Avenue West-11 | 2328 |
| Weigang | Huizhou Avenue West-12 | 2484 |
| Weitang | Huizhou Avenue West-13 | 1274 |
| Material Market East | Huizhou Avenue West-14 | 212 |
| Instrument And Meter Plant | Huizhou Avenue West-15 | 524 |

(3) The location of the passenger flow corridor was determined. Station passenger flow data on Jun. 15, 2022, in Hefei City was selected. A largest station passenger flow Sₘₐₓ in a current time period was dynamically selected. The largest passenger flow on Jun. 15, 2022 in Hefei City was shown in Table 4.

TABLE 4

| Station Name | Road No. | Passenger Flow |
|---|---|---|
| Dazhonglou North | 2812 | Huizhou Avenue-West |

A hierarchical division was obtained by substituting the data of the largest station passenger flow based on the criteria of Sₘₐₓ in combination with a design model, which may be classified into the results shown in Table 5.

TABLE 5

| Grade | Classification Criteria |
|---|---|
| Grade I | 2249.6 ≤ Sᵢ < 2812 |
| Grade II | 556.4 ≤ Sᵢ < 1112.8 |
| Grade III | Sᵢ < 556.4 |

The station passenger flow data of the “new road” on Huizhou Avenue-West obtained in step (2) was selected and allocated to different grades. After the data was substituted into the model, results were shown in Table 6.

TABLE 6

| | | | | Selection | |
|---|---|---|---|---|---|
| | | | | of Pas- | |
| | | Pas- | | senger | Comparrison |
| Station | Road | senger | | Flow | of Traffic |
| Name | No. | Flow | Grade | Corridor | Cell |
| Dazhonglou | Huizhou | 2812 | Grade- | 1 | 93% |
| North | Avenue | | I | | |
| | West-1 | | | | |
| Dong | Huizhou | 2308 | Grade- | 1 | 89% |
| Chengang | Avenue | | I | | |
| | West-2 | | | | |
| Gaowangqiao | Huizhou | 22 | Grade- | 0 | / |
| | Avenue | | III | | |
| | West-3 | | | | |
| Guantang | Huizhou | 18 | Grade- | 0 | / |
| | Avenue | | III | | |
| | West-4 | | | | |
| Huimin | Huizhou | 1520 | Grade- | 0 | / |
| | Avenue | | II | | |
| | West-5 | | | | |
| Ling Datang | Huizhou | 1336 | Grade- | 0 | / |
| | Avenue | | II | | |
| | West-6 | | | | |
| Meilan | Huizhou | 770 | Grade- | 0 | / |
| | Avenue | | III | | |
| | West-7 | | | | |
| Meidan | Huizhou | 172 | Grade- | 0 | / |
| | Avenue | | III | | |
| | West-8 | | | | |
| South | Huizhou | 1322 | Grade- | 0 | / |
| Xunmenqiao | Avenue | | II | | |
| North | West-9 | | | | |
| South | Huizhou | 1904 | Grade- | 0 | / |
| Xunmenqiao | Avenue | | II | | |
| South | West-10 | | | | |
| Sipailou | Huizhou | 2328 | Grade- | 1 | 92% |
| | Avenue | | I | | |
| | West-11 | | | | |
| Weigang | Huizhou | 2484 | Grade- | 1 | 81% |
| | Avenue | | I | | |
| | West-12 | | | | |
| Weitang | Huizhou | 1274 | Grade- | 0 | / |
| | Avenue | | II | | |
| | West-13 | | | | |
| Material | Huizhou | 212 | Grade- | 0 | / |
| Market East | Avenue | | III | | |
| | West-14 | | | | |
| Instrument And | Huizhou | 524 | Grade- | 0 | / |
| Meter Plant | Avenue | | III | | |
| | West-15 | | | | |

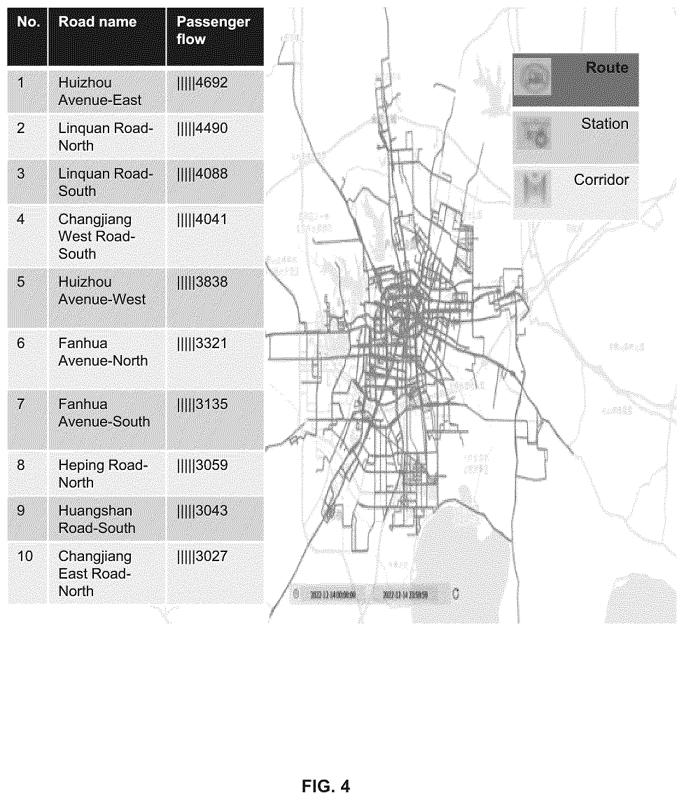

The stations of grade-I were selected according to distribution grades, and a right side of each of the selected stations up to a next station was delineated as the location of the passenger flow corridor. The location of the passenger flow corridor was displayed according to thick and thin markings of line segments, and the location of the passenger flow corridor was mapped across the entire Hefei, as illustrated in FIG. 4.

Accordingly, the card swiping data was used as source data for research, a model for identifying the location of the passenger flow corridor was established, and the location of the passenger flow corridor was eventually determined by comparing the card swiping data with the passenger flow density of the traffic cell. The optimized location of the passenger flow corridor is more accurate and can provide operators with precise data, offering data support for subsequent decision analysis. In addition, a data foundation is provided for reasonable arrangement of bus scheduling plans, thereby ultimately enhancing the quality of public transportation services and passenger satisfaction.

While detailed descriptions of preferred embodiments of the present disclosure have been provided above, it should be understood that the present disclosure is not limited to the aforementioned embodiments. Those skilled in the art may make various modifications within the scope of knowledge in this field without departing from the essence of the present disclosure.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim some embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A method for determining a location of a passenger flow corridor based on card swiping data, the method being executed by a processor, comprising:
S1. collecting data: collecting basic station data of a hardware device of an electronic station board, obtaining passenger flow data during operation, and storing the basic station data and the passenger flow data in an SqI Server database; and pre-processing the basic station data and the passenger flow data, attributing passenger flows of a dynamic GPS point from a GPS point of a station A to a GPS point of a next station in a vehicle-mounted device to the passenger flow of the station A, and storing an obtained total count of passenger flow of a station in the SqI Server database;
S2. obtaining a station passenger flow of a “new road”: calling the passenger flow data of the station and a name of the station stored in the SqI Server database in step S1, and aggregating upward and downward passenger flows according to the name of the station; improving incompleteness when road information is obtained by fitting GPS point data formed in route operation with road data using web GIS, and forming the “new road” after curve fitting by eliminating roads not covered by an urban bus; and obtaining stations and station passenger flows on the “new road” by calling properties of roads to which the stored stations belong to rearrange the stations on the “new road”, wherein the stations on the “new road” are stored as static data, and the passenger flows of the stations on the “new road” are stored as dynamic passenger flows according to a time period;
S3. determining the location of the passenger flow corridor: calling the stations and the passenger flows of the stations on the “new road” obtained in step S2, calculating all the passenger flows of the stations on the “new road” in a whole region in a same time period, and dynamically selecting a largest station passenger flow Sₘₐₓ in a current time period, and classifying the station passenger flows into grade I, grade II, and grade III according to the station passenger flow Sₘₐₓ;
selecting a certain road L, determining a station grade on the road L, dividing a station Sᵢ on the road L into grade I-1₁, grade II-1₂, and grade III-1₃ based on a k-means clustering algorithm, and calculating a proportion of grade 1₁ on the road L; wherein since a location of a largest passenger flow corridor is considered, only a location of a passenger flow corridor that belongs to the grade I is considered;
in response to a sum of passenger flows of at least two consecutive stations on any road L satisfying a preset passenger flow condition, merging the at least two consecutive stations to obtain merged grade I stations, which are added to the grade I-1₁, wherein the preset passenger flow condition includes that the at least two consecutive stations belong to the grade II-1₂ or the grade III-1₃, and the sum of passenger flows of the at least two consecutive stations exceeds a merging threshold; wherein merging thresholds are determined by a process including:
constructing a regional passenger flow map based on all bus stops and road information on the road L, wherein nodes in the regional passenger flow map correspond to each bus stop on the road L, edges in the regional passenger flow map correspond to roads between two adjacent bus stops on the road L; and
determining the merging thresholds of different regions on the road L through a threshold determination model based on the regional passenger flow map, the threshold determination model being generated by training a preliminary machine learning model based on a large count of labeled training samples by the processor, the labeled training samples including training samples and training labels, the training samples and the training labels are determined by the processor; wherein determining the training samples includes:
constructing historical sample regional passenger flow maps as the training samples based on all historical bus stops on historical roads L, historical road information, and historical passenger flows corresponding to the historical bus stops from historical databases; wherein determining the training labels includes:
determining a plurality of virtual locations of passenger flow corridors by a plurality of preset candidate merging thresholds and passenger flows of at least two consecutive stations;
formulating a plurality of virtual bus operation plans basing on the plurality of virtual locations of passenger flow corridors; and
selecting virtual bus operation plans closest to a plurality of historical bus operation plans in the historical databases from the plurality of virtual bus operation plans, and using candidate merging thresholds corresponding to the virtual bus operation plans closest to the plurality of historical bus operation plans as the training labels;
S4. testing an accuracy of the location of the passenger flow corridor: equalizing a traffic cell according to points of interest (POIs), wherein a passenger flow density of the traffic cell equals to a ratio of a passenger flow of the traffic cell to an area of the traffic cell;
for the results of step S3 satisfying a condition, calculating a regional passenger flow density of the results satisfying the condition, and calculating a passenger flow density of the traffic cell divided according to the POIs; in response to a ratio of the regional passenger flow density to the passenger flow density being less than 80%, not determining a road corresponding to the regional passenger flow density as the location of the passenger flow corridor, and in response to the ratio of the regional passenger flow density to the passenger flow density being greater than or equal to 80%, determining the road corresponding to the regional passenger flow density as the location of the passenger traffic corridor, and storing screened results in the SqI Server database; and
S5. displaying the location of the passenger flow corridor through WebGIS: calling the results stored in step S4, displaying the location of the passenger flow corridor according to thick and thin markings of line segments based on the new road fitted by a GIS map to display the location of the passenger flow corridor; wherein
the location of the passenger flow corridor in the step S3 is calculated by a process including:
selecting a certain station Sᵢ on the road L, then
$$\{ \begin{matrix}{S}_{i} ϵ I … {S}_{i} = 1 \\ {S}_{i} ∉ I … {S}_{i} = 0\end{matrix} ;$$
calculating an overall proportion of the station Sᵢ on the road satisfying the condition Sᵢ∈I, then
$${P}_{{I}_{1}} = Σ {S}_{i} / {L}_{s} ;$$
where Lₛ denotes a summary of station passenger flows on the road L;
calculating a proportion of all 1₁ road segments on corresponding roads in the whole region using the method, and comparing the proportion with a standard in the whole region, wherein roads of which P_{I}_{₁} is larger than a standard range are locations of passenger flow corridors in the whole region, which is represented by:
$$\{ \begin{matrix}{P}_{{l}_{1}} \geq \frac{{\sum }_{i = 1}^{n} {P}_{{l}_{1}}}{N} + C … {P}_{{l}_{1}} = 1 \\ {P}_{{l}_{1}} < \frac{{\sum }_{i = 1}^{n} {P}_{{l}_{1}}}{N} + C … {P}_{{l}_{1}} = 0\end{matrix} ;$$
where: P_{I}_{₁} denotes the proportion of 1₁ road segments on the whole road;
N denotes a total count of stations satisfying the condition;
C denotes a constant variable;
i=1 denotes a first station on the road;
n denotes an nth station on the road; and
If P_{I}_{₁}=1, then the roads of which P_{I}_{₁}=1 belong to the locations of the passenger flow corridors in the whole region; if P_{I}_{₁}=0, then the roads of which P_{I}_{₁}=0 do not belong to the locations of the passenger flow corridors in the whole region.

2. (canceled)
